(19) United States
(12) Patent Application Publication
(10) Pub. No.: US 2004/0039747 A1
(43) Pub. Date: Feb. 26, 2004

(54) Retrieval device and retrieval method for object-oriented database

(75) Inventor: Kouichi Katano, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/640,636

(22) Filed: Aug. 14, 2003

(30) Foreign Application Priority Data
Aug. 20, 2002 (JP) 2002-238849

(51) Int. Cl. G06F 7/00

(52) U.S. Cl. 707/100

(57) ABSTRACT

When a partial set meets specific conditions, from a mother set by an inquiry for an object-oriented database, an answer can be obtained by solving backward the last conditional equation of an inquiry equation given by navigation.

### BACKGROUND OF THE INVENTION

1. Field of the Invention

The present invention relates to a retrieval device for executing an inquiry in order to retrieve a prescribed aggregate of data from an object-oriented database.

2. Description of the Related Art

In an object-oriented database, each segment of data is stored as an object. Each object belongs to a class and has attributes that are defined for each class. For example, if an attribute “name” is set in a class “human being” as an attribute value, a variety of names are stored in the class “human being” as attributes. In an object-oriented database, objects can be related to each other. If in the sub-class “sex” inheriting the class “human being”, the attribute values of the class “human being” are classified by an attribute value of either “male” or “female”.

In this way, in an object-oriented database, each segment of data stored as an object is classified for each class and a plurality of segments of data are related to each other in a form of “inheritance”. For example, it is assumed that a user of an object-oriented database wants to extract only females from “names” registered in the class “human being”. In order to extract a set with a specific attribute value from an object-oriented database, the user connects object names, describes them in a form of equation, sets conditions and requests a system to obtain the data for him. This conditional equation in a form of connected object names for setting conditions to this aggregate to be extracted is called “navigation”.

If an object that meets the designated conditions is retrieved from a mother set using an inquiry for an object-oriented database, the mother set is designated as a retrieval target and navigation is traced in order for each element of the target object. Then, it is determined whether the last navigation destination object meets the designated conditions and the result aggregate of the inquiry is generated.

FIG. 1 shows the relationship between classes and attributes in an object-oriented database.

As shown in FIG. 1, there are objects a1 through a5 in class A. An object is set in each attribute. Each of the objects a1 through a5 is provided with a link B, which connects class A to class B. FIG. 1 shows the simplest connection. Object a1 in class A is linked to object b1 in class B. Similarly, links B through E are established between classes A and B, classes B and C, classes C and D and classes D and E, respectively.

An attribute “property” is set in each of objects e1 through e5 in class E. In this case, if a set of objects in the class A that are related to an object having an attribute property “ghi” in class E is extracted from the entire set of objects in class A, a database is retrieved using the following inquiry equation or conditional equation:

classA.linkB.linkC.linkD.linkE.property==“ghi” (1)

In this way, an equation describing links between classes is called “navigation”. By retrieving a database according to this navigation, a partial set of objects in class A that are related to an object having a property “ghi” in class E can be obtained from the entire set of objects in class A.

If such an inquiry is executed conventionally, navigation must be traced in the appropriate order. In this case, the navigation is traced in the appropriate order for each element of an inquiry mother set, the last navigation destination object is detected and it must be checked whether the object meets inquiry conditions. If a mother set, which is an inquiry target, has many elements and if the number of objects that meet the inquiry conditions is far smaller than that of the elements of the mother set, a lot of time is wasted before the navigation solution can obtain the last navigation destination object. If the number of objects that meet the inquiry conditions is large, process time spent on the navigation cannot be neglected.

FIG. 2 shows a conventional navigation solution method.

It is assumed that there are objects a1 through a5 in class A. In this case, if the navigation (1) is given as an inquiry equation, firstly, links are traced from each object in class A to each object in class B, since class A is related to class B. By doing this, sets of a1 and b1, a2 and b2, a3and b3, a4 and b4, and a5 and b5 are extracted. Next, since classes B and C are related, links C are traced from each of the sets obtained by tracing the links B, to each object in class C. By doing this, relationship between a1 and c1, a2 and c2, a3 and c3, a4 and c4, and a5 and c5 are detected. Similarly, links D and E are traced, and sets of a1 and e1, a2 and e2, a3and e3, a4 and e4, and a5 and e5 are extracted. A conditional equation is designed to detect an object in class A that is related to an object having a property “ghi” in the class E. Therefore, in FIG. 1, e3 is selected as the object having a property “ghi” in class E, and a3 that is set with e3 is obtained as the answer to the inquiry.

FIG. 3 shows the direction of the conventional navigation solution.

As shown in FIG. 3 and as described in FIG. 2, navigation conducted by a system in order to solve the navigation (1) traces objects in classes A through E in the order given by the equation (1), and by judging whether the attribute of the last object meets the set conditions, it is judged whether a corresponding object in class A meets the conditions. Specifically, this process must be applied to all the objects in class A, and all the connections between classes that are described in the navigation connected to all the objects in class A must be traced.

FIG. 4 shows another example of the conventional navigation.

In this case, objects a1 through a8 are defined in a class A, and when links B are traced, it is found that a group of two objects in class A are related to a single object in class B. Specifically, a1/a2 and b2, a3/a4 and b4, a5/a6 and b6, and a7/a8 and b8, respectively, are related. Similarly, when links C are traced, it is found that b1/b3 and c3, b2/b4 and c4, b5/b7 and c7, and b6/b8 and c8, respectively, are related.

FIG. 5 shows an example of the conventional solution method of the navigation shown in FIG. 4.

As shown in FIG. 5, when the relationship between each object in class A and each object in class C is obtained by tracing links B and C, an object c4 that has an attribute “ghi” is extracted (see FIG. 4). In this case, a1 through a4 that are related to c4 constitute a target set.

FIG. 6 shows the number of times a link is traced.

In link B, each object in class A is linked to one corresponding object in class B, only one link tracing is required for each object. However, in link C between classes B and C, since b2 is linked with a1 and a2, respectively, at b2 two links must be traced backward. Similarly, at b4, b6 and b8 too, two links must be traced backward. Therefore, even when links are collectively traced forward, the number of links needed to be traced to solve navigation does not decrease.

Therefore, if there are many objects in class A (there are many elements in a mother set), it takes a long time to obtain the final answer, since a link must be traced for all objects.

### SUMMARY OF THE INVENTION

It is an object to provide a retrieval device for shortening retrieval time.

A retrieval device according to the present invention is used to retrieve data from within an object-oriented database. The retrieval device comprises an inquiry input unit inputting an inquiry for an object-oriented database, an inquiry analysis unit analyzing navigation described in the inquiry, a backward navigation solution unit evaluating the last conditional equation described in navigation and solving the last conditional equation described in the navigation in a direction the reverse of that of the description, and a result collection unit collecting results obtained by solving the described backward navigation.

A retrieval method according to the present invention is used to retrieve data from within an object-oriented database. The retrieval method comprises inputting an inquiry for an object-oriented database (inquiry input step), analyzing navigation described in the inquiry (analysis step), evaluating the last conditional equation described in the navigation and solving the last conditional equation described in the navigation in a direction the reverse of that of the description (navigation backward solution step) and collecting results obtained by solving the described backward navigation (result collection step).

According to the present invention, if an inquiry for extracting a partial set that meets prescribed conditions from a mother set having many elements is inputted into an object-oriented database, navigation used to describe the inquiry is solved backward from the last description. Therefore, the number of links needed to be traced to obtain a prescribed result can be reduced. Therefore, the operation speed of the database system can be improved.

### BRIEF DESCRIPTION OF THE DRAWINGS

FIG. 1 shows relationship between classes and attributes of an object-oriented database;

FIG. 2 shows a conventional navigation solution method;

FIG. 3 shows the direction of a conventional navigation solution;

FIG. 4 shows another example of the conventional navigation.

FIG. 5 shows the conventional solution method of the navigation shown in FIG. 4;

FIG. 6 shows the number of times links are traced in the case shown in FIG. 4;

FIG. 7 shows the principle of the retrieval method according to the preferred embodiment of the present invention;

FIG. 8 shows the concept of a method for solving backward navigation according to the preferred embodiment of the present invention;

FIG. 9 shows another example of a retrieval method according to the preferred embodiment of the present invention;

FIG. 10 shows another example of the process concept of the preferred embodiment of the present invention;

FIG. 11 is a flowchart showing the process of solving navigation according to the preferred embodiment of the present invention;

FIG. 12 is a flowchart showing the process of automatically establishing links that are the reverse of the links set by a user, of a system according to the preferred embodiment of the present invention;

FIGS. 13A through 13C show examples of a class definition screen according to the preferred embodiment of the present invention;

FIGS. 14A through 14C show examples of class tables generated by a class definition;

FIG. 15 shows examples of the object setting of a link attribute and a stored data structure;

FIG. 16 is a flowchart showing a process performed when the system establishes reverse links based on FIGS. 13A through 15;

FIG. 17 shows an example of an input designation screen used for a user to input retrieval conditions;

FIG. 18 shows a specific example of a backward navigation solution process according to the preferred embodiment of the present invention (No. 1);

FIG. 19 shows a specific example of a backward navigation solution process according to the preferred embodiment of the present invention (No. 2);

FIGS. 20A and 20B show a specific example of a backward navigation solution process according to the preferred embodiment of the present invention (No. 3);

FIG. 21 shows a pseudo-code representing a process algorithm according to the preferred embodiment of the present invention (No. 1);

FIG. 22 shows a pseudo-code representing a process algorithm according to the preferred embodiment of the present invention (No. 2); and

FIG. 23 shows the hardware configuration of a data processing device executing a program if the process of the preferred embodiment of the present invention is realized by a program.

### DESCRIPTION OF THE PREFERRED EMBODIMENTS

In the present invention, the reverse links of navigation are established in advance. Firstly, a set of the last navigation destination objects that meet the inquiry conditions is obtained by checking which object of a class to which the last navigation destination object belongs, meets the inquiry conditions. Then, a result set can be extracted from an inquiry mother set by tracing reverse links from the elements of the obtained set and solving the navigation backward.

However, if the number of the last navigation destination objects that meet the inquiry conditions is the same as the number of elements of the mother set, there is no merit in tracing the navigation backward.

Therefore, a user designates whether the present invention of executing an inquiry by solving navigation backward should be applied, for each inquiry.

It is assumed that the following inquiry conditional equation is given:

select classA from classA

where classA.linkB.linkC.linkD.linkE.property==“ghi” (3)

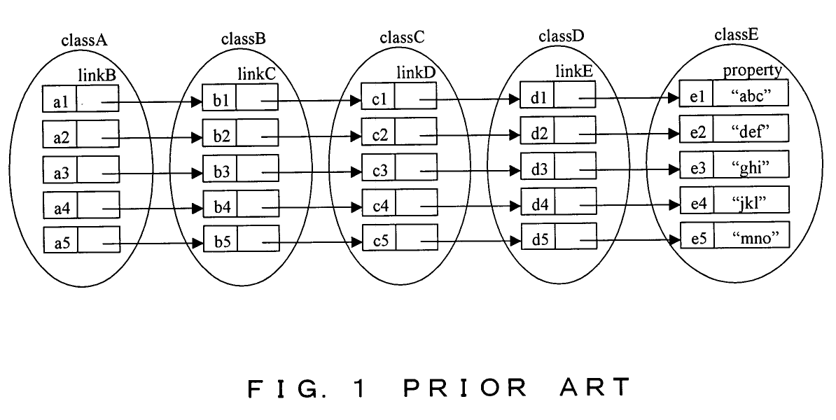

In this case, class A is the target class of an inquiry and instances (attributes) belonging to this class constitute the mother set of this inquiry equation. Each of LinkB, linkC, linkD and linkE represents one piece of navigation and the property is the last navigation destination. In this case, the relationship between classA, classB, classC, classD and Class E is as shown in FIG. 1.

Ellipses, rectangles and arrow marks represent classes, attributes and navigation, respectively.

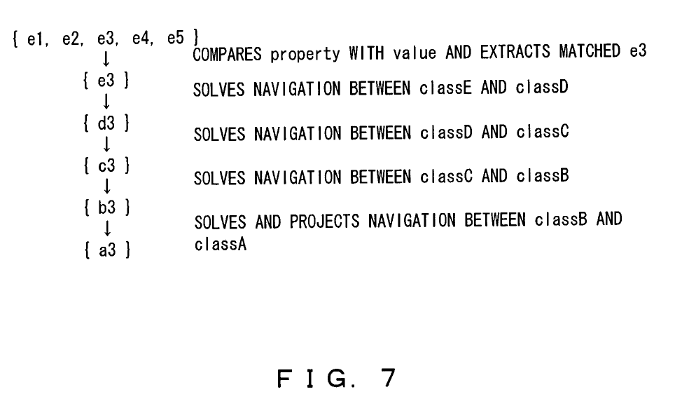

FIG. 7 shows the concept of solving the navigation of linkB, linkC, linkD and linkE backward, of each instance (attribute) belonging to the class A, if the relationship between classes is as shown in FIG. 1.

FIG. 7 shows the principle of a retrieval method according to the preferred embodiment of the present invention.

Firstly, an object e3, whose attribute is “ghi”, in class E is extracted. Then, navigation described rightward in the equation (3) is traced leftward. Then, d3 is selected by tracing link D from class E to class D. Then, b3 is selected by tracing link C from class D to class C. Then, a3 is obtained as an answer by tracing link B from class B to class A.

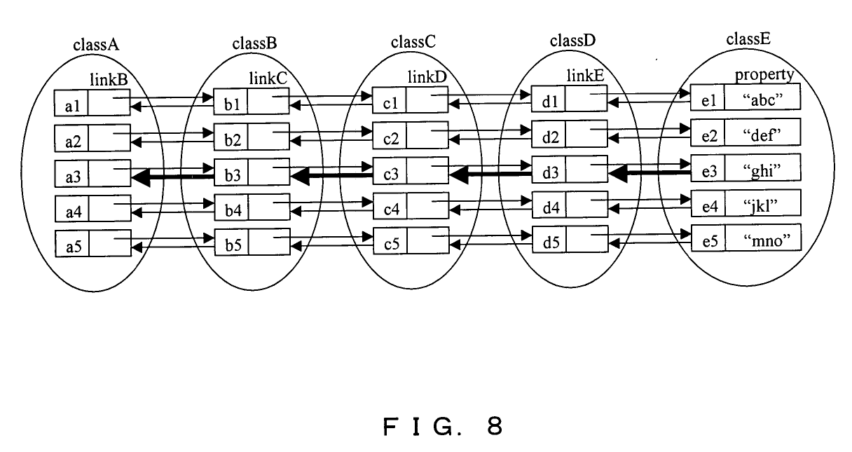

FIG. 8 shows the concept of a method for solving navigation backward according to the preferred embodiment of the present invention.

As shown in FIG. 8, if a user establishes links from class A to class B, from class B to a class C, from the class C to a class D and from the class D to class E, the system automatically establishes their reverse links. Therefore, the links can be traced backward from class E toward class A.

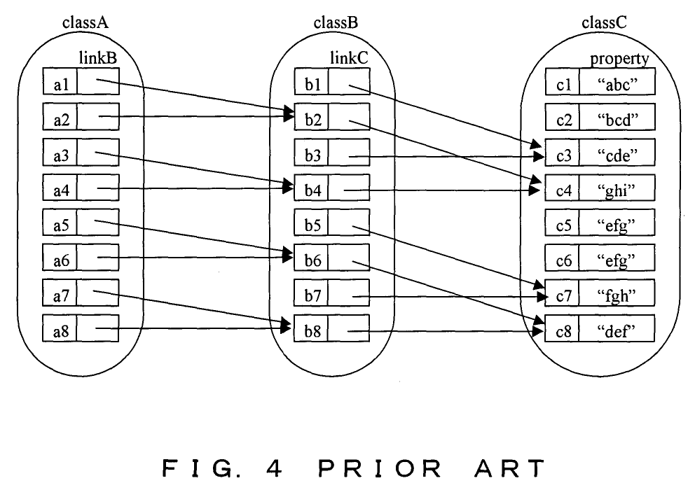

Here, the relationship between classes A, B, C, D and E is as shown in FIG. 4, is assumed.

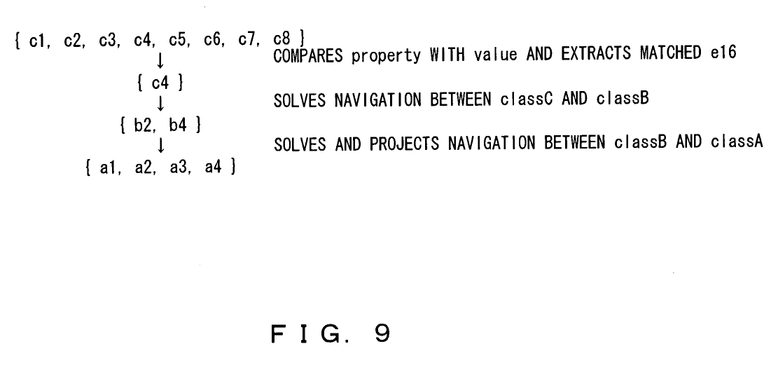

FIG. 9 shows the concept of solving navigation backward using reverse links according to the preferred embodiment of the present invention, if relationship between classes A, B, C, D and E is as shown in FIG. 4.

FIG. 9 shows another example of a retrieval method according to the preferred embodiment of the present invention.

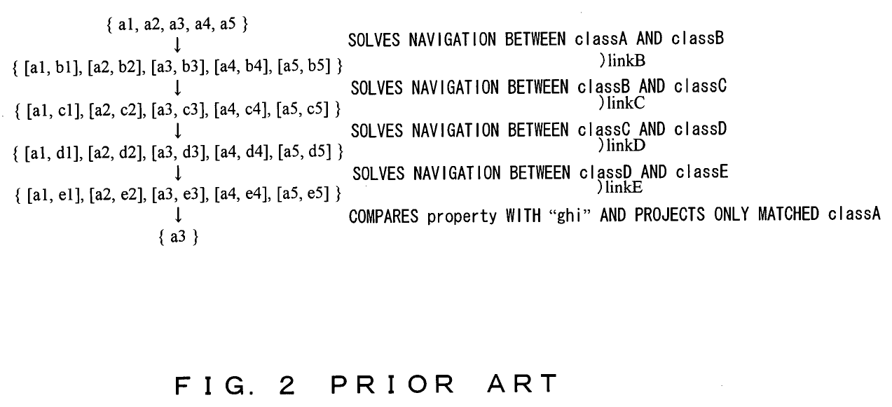

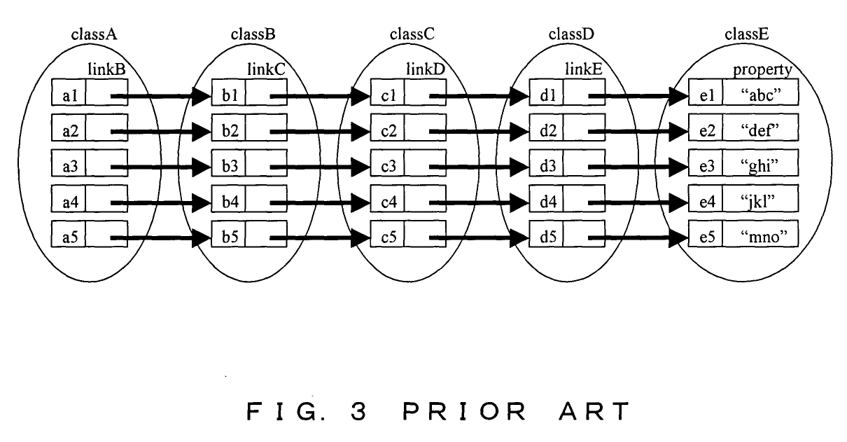

The reason why an inquiry can be more appropriately executed by solving navigation backward using reverse links than by solving it forward, is described below. If the relationship between classes is given by the equation (3) when navigation is solved by the conventional method, the concept is as shown in FIG. 2. Five pieces of navigation (the navigation of five attributes in class A) must be solved to reach class B from class A. Similarly, five pieces of navigation must be also solved to reach class C from class B. If the last navigation from class D to class E is solved, similarly, five pieces of navigation must be solved, since the value of the property is unknown. In this way, it is found that it takes a long time to obtain the last set.

link( )*num(classA)+link( )*num(classA)+link( )*num(classA)+link( )*num(classA)=link( )*num(classA)*4

In the above equation, link( ) indicates time needed to solve one piece of navigation and num( ) is a function indicating the number of the elements of a set.

However, if navigation is solved backward using reverse links, it is found that it takes the following time to obtain the last set:

link( )+link( )+link( )+link( )=link( )*4

It is clear that navigation can be optimally solved backward.

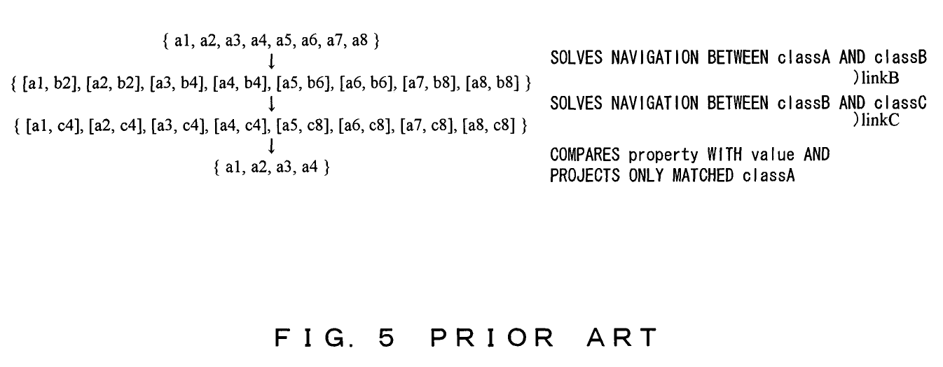

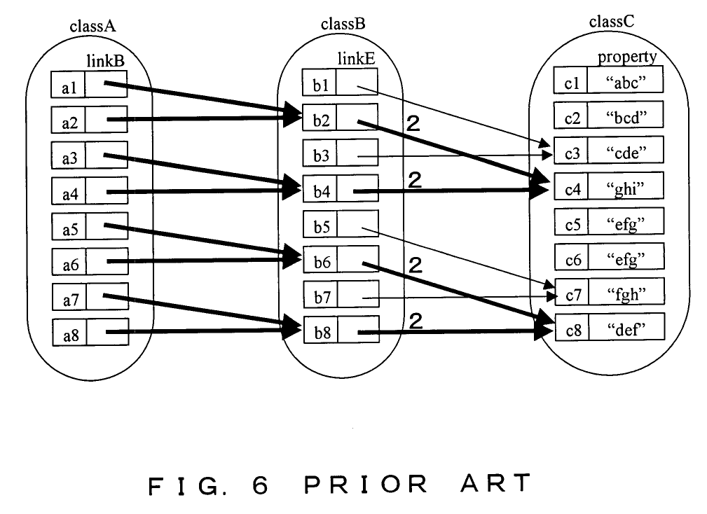

Similarly, if the equation (3) is given when the relationship between classes is as shown in FIG. 4, the concept of the conventional navigation is as shown in FIG. 5. In this case, if the navigation is solved forward by the conventional method, it is found that it takes the following time to obtain the last set:

link( )*num(classA)+link( )*num(classA)=link( )*num(classA)*2

However, if navigation is solved backward using reverse links, it is found that it takes the following time to obtain the last set:

Link( )*2+link( )*4=link( )*6<link( )*num(classA)*2

In this case too, it is clear that navigation can be optimally solved backward. FIG. 10 shows this concept.

Specifically, FIG. 10 shows another example of the process concept of the preferred embodiment of the present invention.

In FIG. 10, thick arrow marks represent navigation, and the navigation is given by the equation (2). In the preferred embodiment of the present invention, since navigation is solved backward, an object c4, whose value of property is “ghi”, in class C is extracted. Then, when the navigation is solved backward from c4, b2 and b4 in class B are obtained. The navigation is further solved backward, a1,a2, a3 and a4 in class A are obtained from b2 and b4 in class B. Therefore, the answer is a1 through a4.

Therefore, if the number of the last navigation destination objects that meet the designation conditions is far smaller than that of the elements of an inquiry mother set, an inquiry can be optimally executed by solving navigation backward using reverse links.

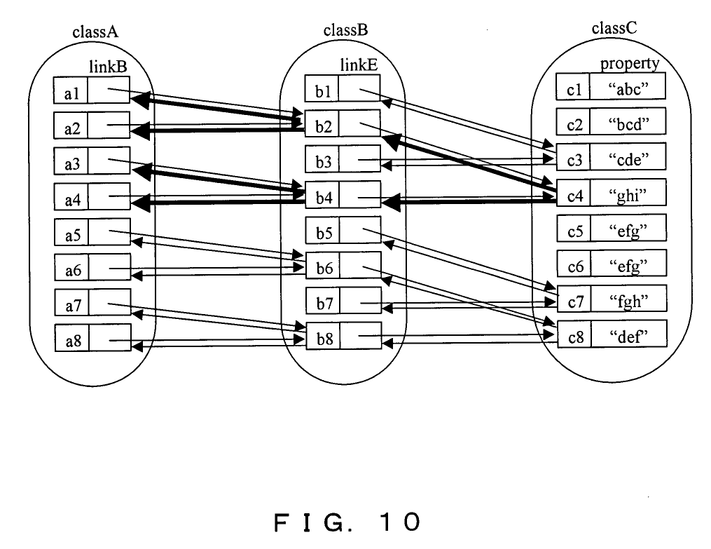

FIG. 11 is a flowchart showing the process of solving navigation according to the preferred embodiment of the present invention.

Firstly, in step S1, a user input a conditional equation. In step S2, a device or system according to the preferred embodiment of the present invention analyzes the conditional equation, and in step S3, it analyzes navigation. Then, in step S4, it is judged whether the user has designated the backward solution of the navigation. If the user has not designated the backward navigation solution, the process proceeds to step SS and a reply to the user's inquiry is generated by the conventional navigation solution method. Since the process in step S5 is conventional, the description is omitted.

If in step S4 the user has designated the backward navigation solution, in step S6 an object that meets the last condition described last in the navigation is selected from a class that is described last in the navigation. Then, in step S7, the description in navigation is solved backward from the tail end using reverse links. As in this case, sometimes a specific object has two or more reverse links when the navigation is solved backward. The device or system is designed not to trace the other links other than those described in the navigation, that the user has not inputted. Then, in step S9, the last result set is generated and the process is terminated.

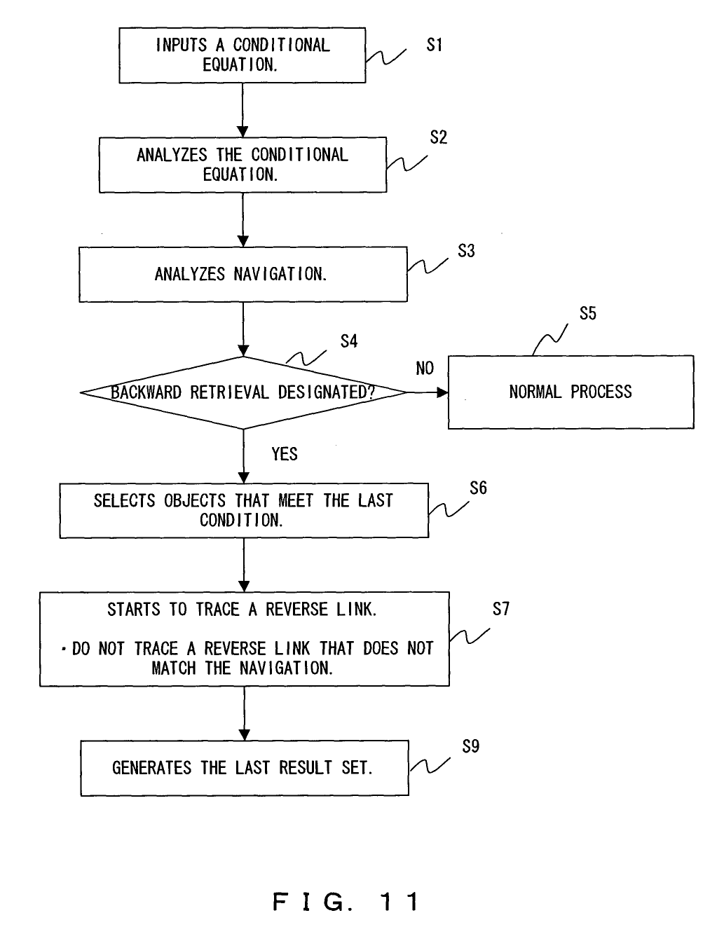

FIG. 12 is a flowchart showing the process of a system according to the preferred embodiment of the present invention, that automatically establishes links the reverse of those set by a user.

In step S15, a user declares a link attribute. In step S16, the attribute for reverse links is generated in a link destination class. In step S17, the user designates an object having the attribute, and in step S18, reverse links are established.

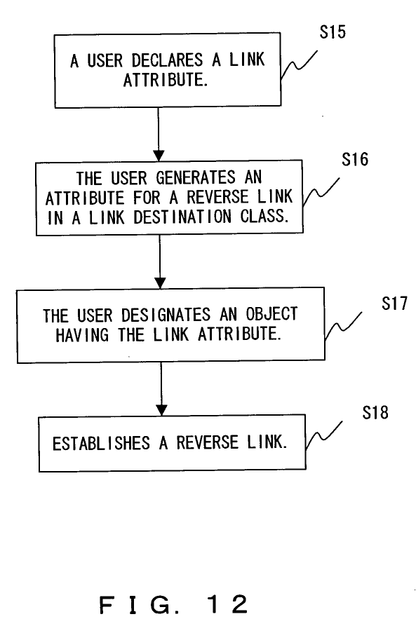

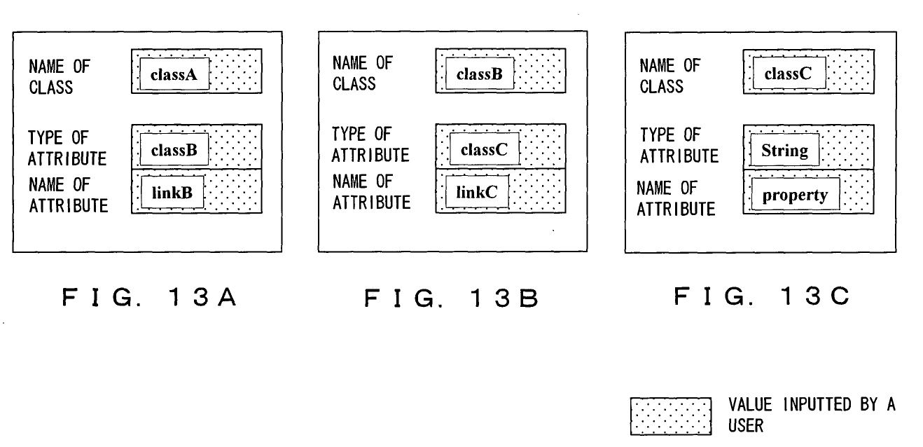

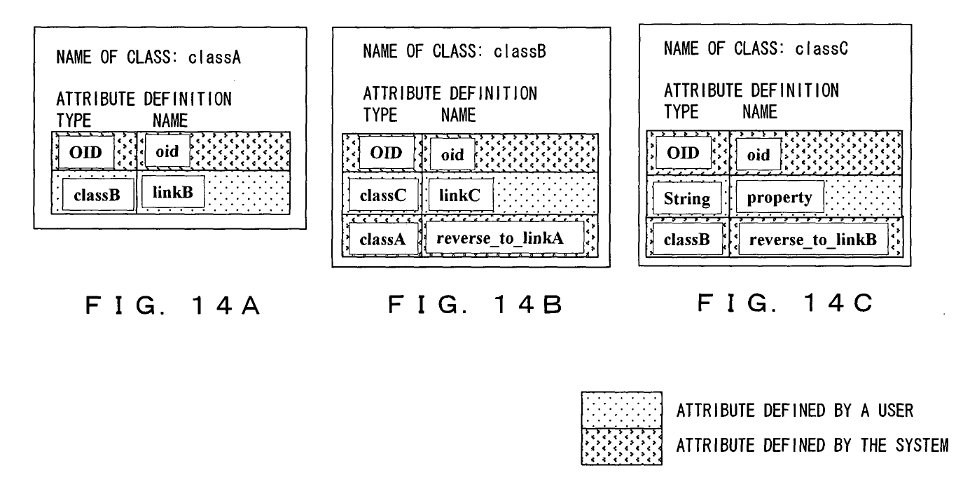

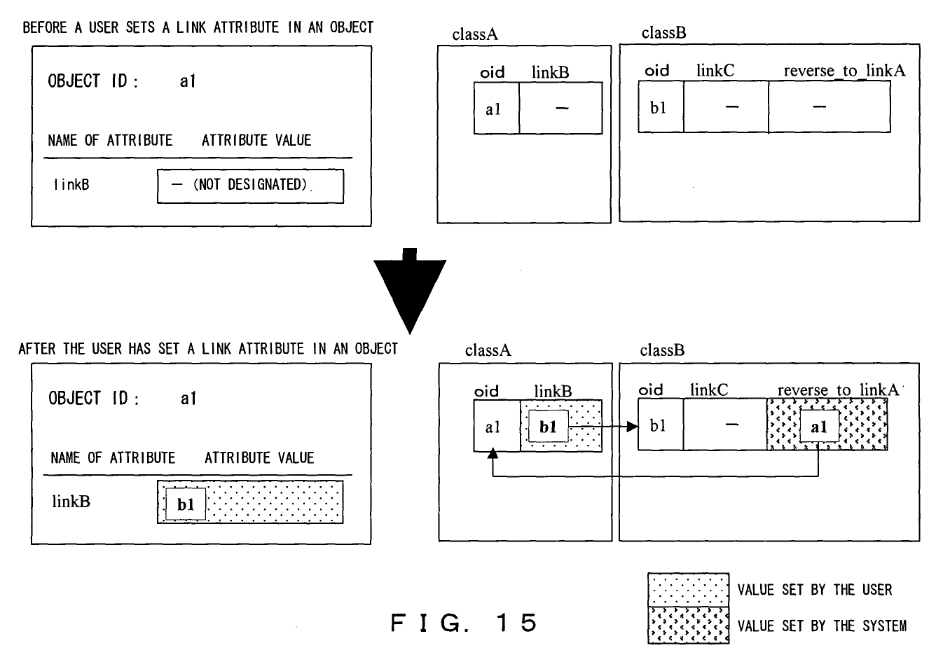

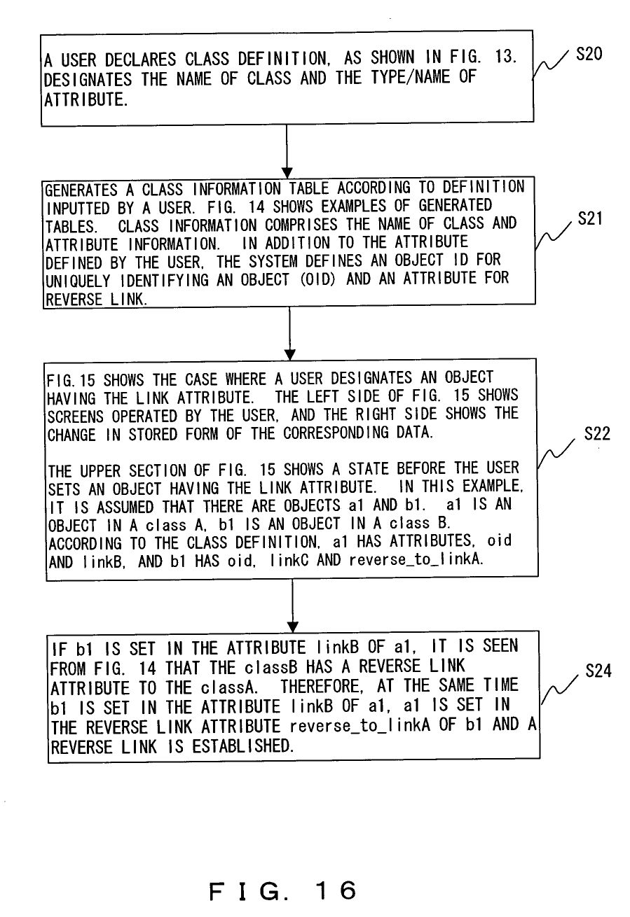

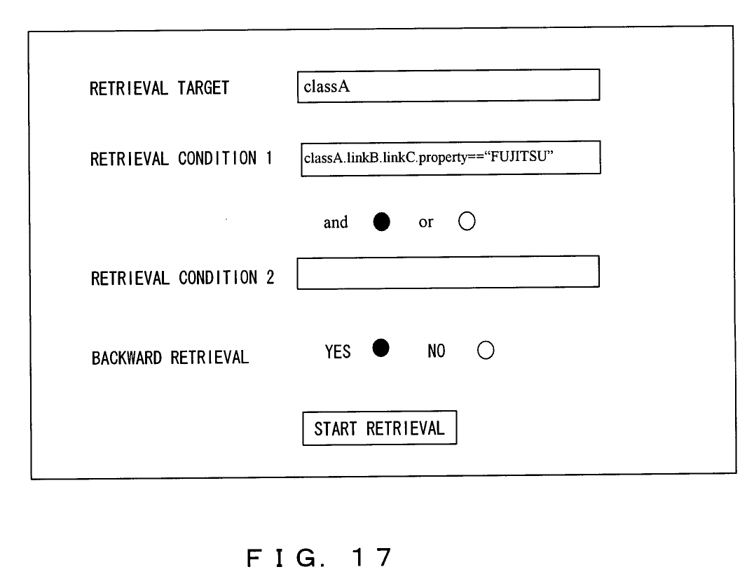

FIG. 13 shows an example of a user's definition screen used when the user declares a link attribute. FIG. 14 shows an example of a state where the system has automatically generated the attribute for reverse links in class information according to the user's definition made in step S16. FIG. 15 shows the case where the user designates an object for the attribute and the case where a reverse link is established for data stored in the system.

FIG. 13A shows an example of a class definition screen according to the preferred embodiment of the present invention.

In FIG. 13A, the name of class, the type of attribute and the name of attribute are set as values to be inputted by a user. In FIG. 13A, “classA”, “classB” and “linkB” are set as the name of class, the type of attribute and the name of attribute, respectively. In this way, a link B is established from a class A to a class B.

In FIG. 13B, “classB”, “classC” and “linkC” are set as the name of class, the type of attribute and the name of attribute, respectively. In this way, a link C is established from the class B to a class C.

In FIG. 13C, “classC”, “String” and “property” are set as the name of class, the type of attribute and the name of attribute, respectively. In this way, it is defined that “String”, that is, a character string, is set in the property of a class C.

FIGS. 14A through 14C show examples of class tables generated by class definitions.

FIG. 14A shows a class table generated by the user definition shown in FIG. 13A. In FIG. 14A, an attribute having a type “OID” and a name “oid” are set as the attribute definition of a class name “classA”. This is the ID of an object belonging to class A. As a subsequent attribute, an attribute having a type “classB” and a name “linkB” are set. In this way, a linkB is established from the class A to a class B.

FIG. 14B shows a class table generated by the user definition shown in FIG. 13B. In FIG. 14B, as the attribute definition of the name of a class “classB”, the object ID of class B is set, and link C is established from class B to class C. Furthermore, when link B is established from class A to class B, the system automatically establishes a reverse link having “reverse_to_linkA” and “classA” as the name and type of attribute, respectively.

FIG. 14C is a class table generated by the user definition shown in FIG. 13C. In FIG. 14C, the system sets the object ID of class C as the attribute definition of a class name “classC”, and simultaneously a user sets an attribute of type “String” and an attribute of name “property”. Furthermore, the system automatically establishes a reverse link “linkC” having “classB” and “reverse_to_linkB” as the type and name of attribute, respectively.

FIG. 15 shows examples of the object setting of a link attribute and a stored data structure.

In FIG. 15, the two screens located on the left side show screens for a user to establish a link between two segments of data, and the two diagrams located on the right side show data structures stored in memory by a user setting.

When a user establishes a link between objects, firstly, the screen located in the upper left section of FIG. 15 is displayed. On this screen, al, being the ID of an object in which the user sets a link attribute, is displayed and “linkB” is displayed as the attribute name of the link. In this case, the attribute value of “linkB” is not designated before the user sets the link attribute. The data structures at this moment is as shown in the upper right section. Specifically, in the data of class A, “a1” is set as an object ID (which has the attribute described above, and whose type and name are “OID” and “oid”, respectively), and nothing is set in “linkB”. In the data of class B, “b1” is set as an object ID (whose type and name are “OLD” and “oid”, respectively), and nothing is set in “linkC” and “reverse_to_linkA”.

After the user has set a link attribute in an object, as shown in the screen located in the lower left section of FIG. 15, “b1” is already set as the attribute value of “linkB” by user designation. In this case, as shown in the drawing located in the lower right section of FIG. 15, in data, “b1” is set as the value of an attribute “linkB” of an object, whose ID is “a1”, in class A. At this moment, a link is established from object “a1” in class A to object “b1” in class B. This is “linkB”. Although link B is established by the user, the system establishes a reverse link “reverse_to_linkA” from object “b1” in class B to object “a1” in class A when link B is established by the user. In this data field, the object ID of object “a1” in class A is set. In this way, a link is established from object “a1” to object “b1” by a user, and simultaneously a link is established from object “b1” to object “a1” by the system.

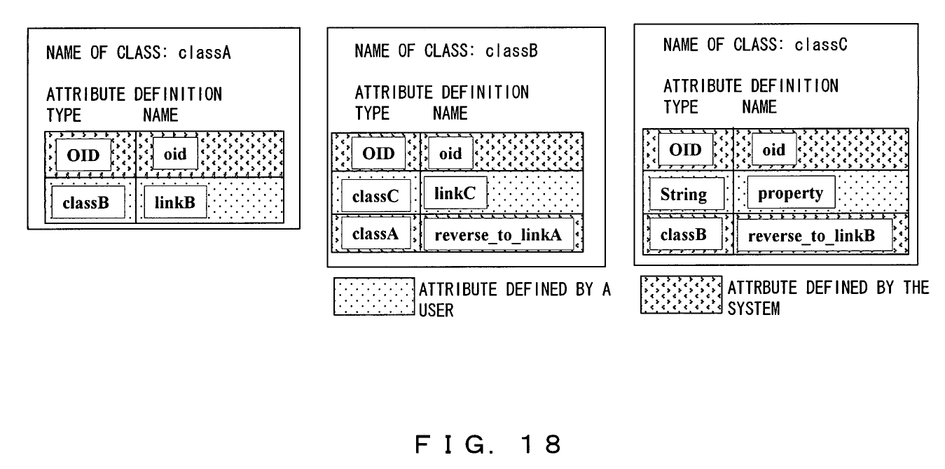

FIG. 16 is a flowchart showing the process of establishing a reverse link, based on the drawings shown in FIGS. 13A through 15.

Firstly, in step S20, as shown in FIGS. 13A-13C, a user declares a class definition and designates the name of the class and the type/name of attribute. In step S21, a table that stores class information is generated according to the definition inputted by the user. FIG. 14 shows such generated tables. Class information comprises the name of the class and attribute information. In addition to the attribute defined by the user, an object ID (OID) for uniquely identifying an object and an attribute for a reverse link are defined by the system.

FIG. 15 shows the case where in step S22, a user designates an object having a link attribute. How to read the drawings shown in FIG. 15 has been already described. In FIG. 15, it is assumed that there are objects a1 and b1. a1 is an object in class A, and b1 is an object in class B. a1 has “a1” and “linkB” as oid and attribute, respectively. b1 has “b1” as oid and has “linkC” and “reverse_to_linkA” as attributes. If in step S24, “b1” is set in the attribute “linkB” of al, the system can judge that class B has the reverse link to class A, based on the table shown in FIG. 14. Therefore, the system sets “b1” in the attribute “linkB” of al. Simultaneously, the system sets “a1” in the reverse link attribute “reverse_to_classA” of b1 and establishes a reverse link.

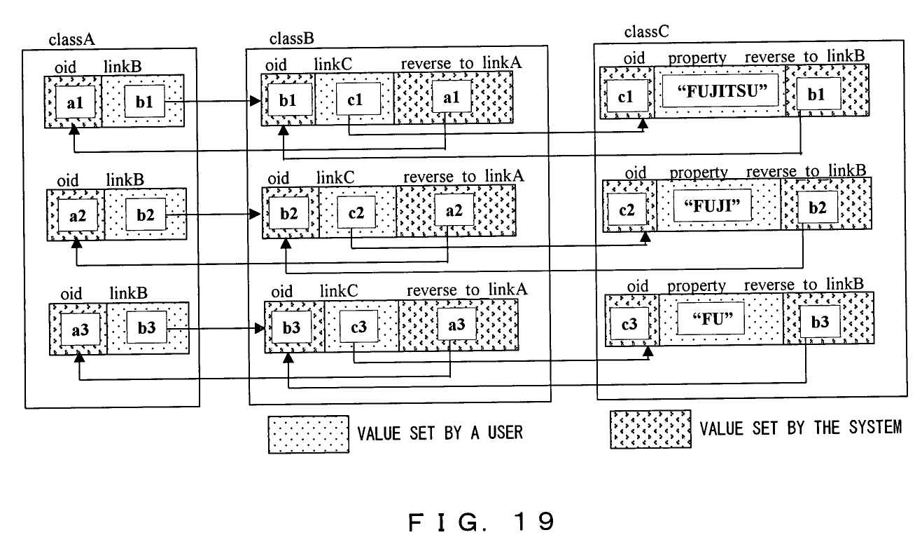

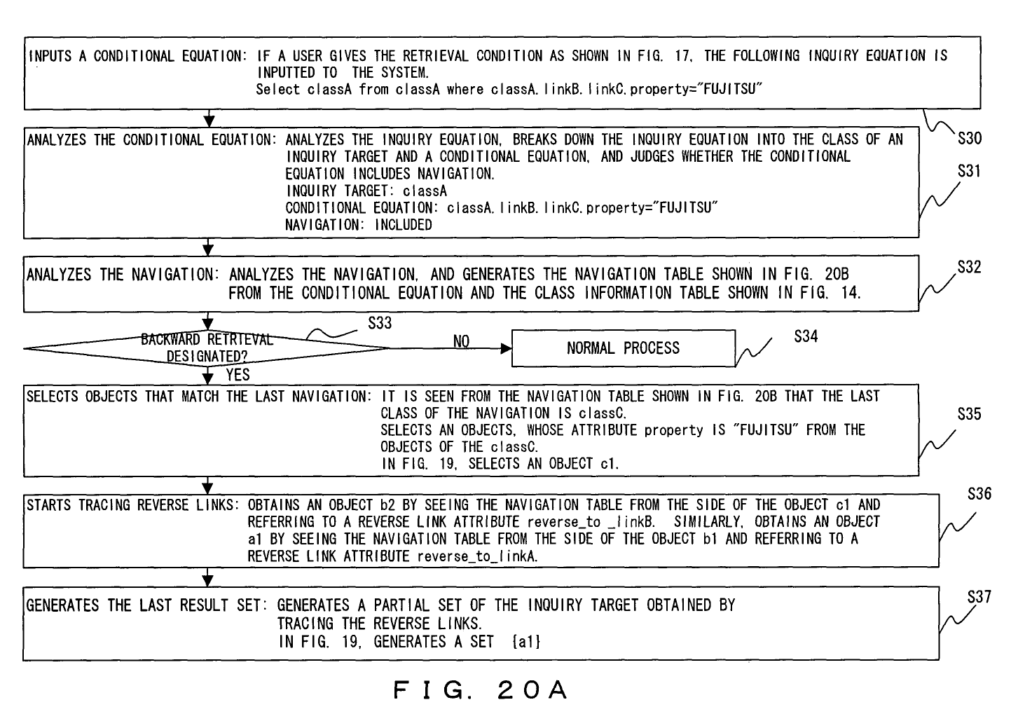

FIG. 17 shows an example of an input designation screen on which a user inputs retrieval conditions.

In FIG. 17, “classA” is designated as a retrieval target, and “classA.linkB.linkC.property==“Fujitsu”” is inputted as a retrieval condition. This is navigation. Although a second retrieval condition can be inputted, in this example, no second condition is inputted. If retrieval is conducted using retrieval conditions 1 and 2, the two retrieval conditions 1 and 2 can be connected using “and” or “or”. With regards to the retrieval, whether or not backward retrieval according to the preferred embodiment of the present invention, is conducted can be designated. If a user pushes the retrieval start button after inputting the retrieval condition, the system starts the retrieval.

FIGS. 18 through 20 show specific examples of a backward navigation solution process according to the preferred embodiment of the present invention.

FIG. 18 shows example data of a class information table. In the examples of FIGS. 18 through 20, it is assumed that classes are already defined as shown in FIG. 18. It is defined in class A that an attribute, whose type and name are “OID” (type of object ID) and “oid”, respectively, and an attribute, whose type and name are “classB” (type of the object ID of an instance in class B) and “linkB”, respectively, constitute one instance. It is defined in class B that an attribute, whose type and name are “OID” and “oid”, respectively, an attribute, whose type and name are “classC” and “linkC”, respectively, and an attribute, whose type and name are “classA” and “reserve_to_linkA”, constitute one instance. It is defined in class C that an attribute, whose type and name are “OID” and “oid”, respectively, an attribute, whose type and name are “String” and “property”, respectively, and an attribute., whose type and name are “classB” and “reverse_to_linkB”, constitute one instance.

In FIG. 19, instances in class A, whose “oid” is “a1”, “a2” and “a3”, respectively, are specifically shown, and in the attribute “linkB” of these instances, “b1”, “b2” and “b3”, which are the IDs of the respective corresponding link destinations in the class B, are set.

In the instances of class B, links are established from instances in class A to their corresponding objects, whose “oid” are “b1”, “b2” and “b3”. In order to establish their links to the instances in class C, their corresponding object IDs of the instances in class C are set in the “linkC”, and a reverse link from their corresponding instances in class B to their corresponding instances in class A are set in the “reverse_to_linkA”.

In the instances of class C, links are established from their corresponding instances in class B, and a real character string, whose attribute name and type are “property” and “String”, respectively, and the object IDs of their corresponding instances in class B are set in the corresponding objects, whose object IDs are “c1”, “c2” and “c3”, and an attribute name “reverse_to_linkB” for establishing reverse links from the instances in class C to their corresponding instances in class B, respectively.

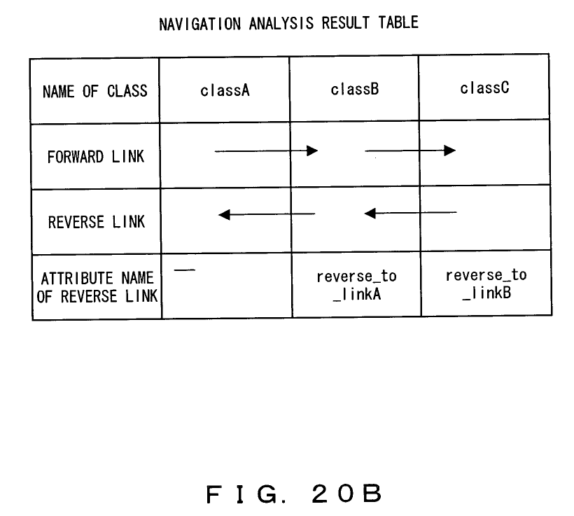

FIGS. 20A and 20B show the process of solving navigation backward based on FIGS. 17 through 19.

The process is described below with reference to the flowchart shown in FIG. 20A.

Firstly, if in step S30, a user inputs retrieval conditions as shown in FIG. 17, the following inquiry equation is provided to the system:

Select classA from classA where classA.linkB.linkC.property==“Fujitsu”

Then, in step S31, the inquiry equation is analyzed and is broken down into an inquiry target class and a conditional equation, and it is judged whether the conditional equation includes navigation. As a result, the following are obtained:

Inquiry target class: class A

Conditional equation:

classA.linkB.linkC.property==“Fujitsu”

Navigation: Yes

Then, in step S32, the navigation is analyzed and the navigation table shown in FIG. 20B is generated from the conditional equation and class information table shown in FIG. 14.

In step S33, it is judged whether the user has designated backward retrieval. If in step S33, it is judged that the user has not designated backward retrieval, in step S34, normal retrieval is conducted.

If in step S33, it is judged that the user has designated backward retrieval, in step S35, it is judged that the last class of the navigation is class C, by navigation shown in FIG. 20B. Then, an object having an attribute property value “Fujitsu”, in class C is selected. In FIG. 19, object c1 is selected.

In step S36, by seeing the navigation table from the side of object c1 and referring to a backward link attribute “reverse_to_linkB”, object b1 is obtained. Similarly, by seeing the navigation table from the side of object b1 and referring to a backward link attribute “reverse_to_linkA”, object al is obtained.

Then, in step S37, a partial set of the inquiry target, which is obtained using the backward links, is generated. In the example shown in FIG. 19, a set {a1} is generated.

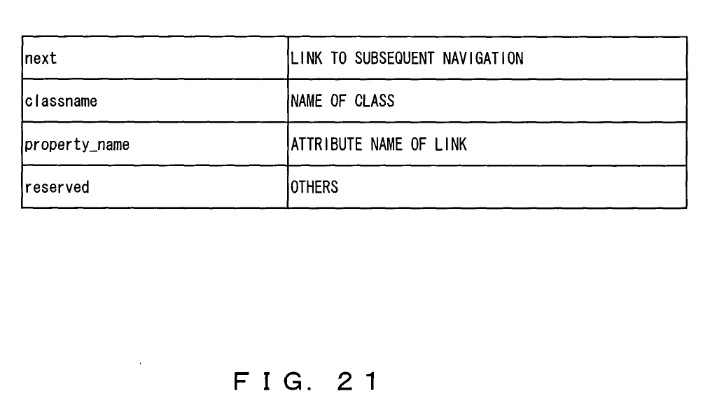

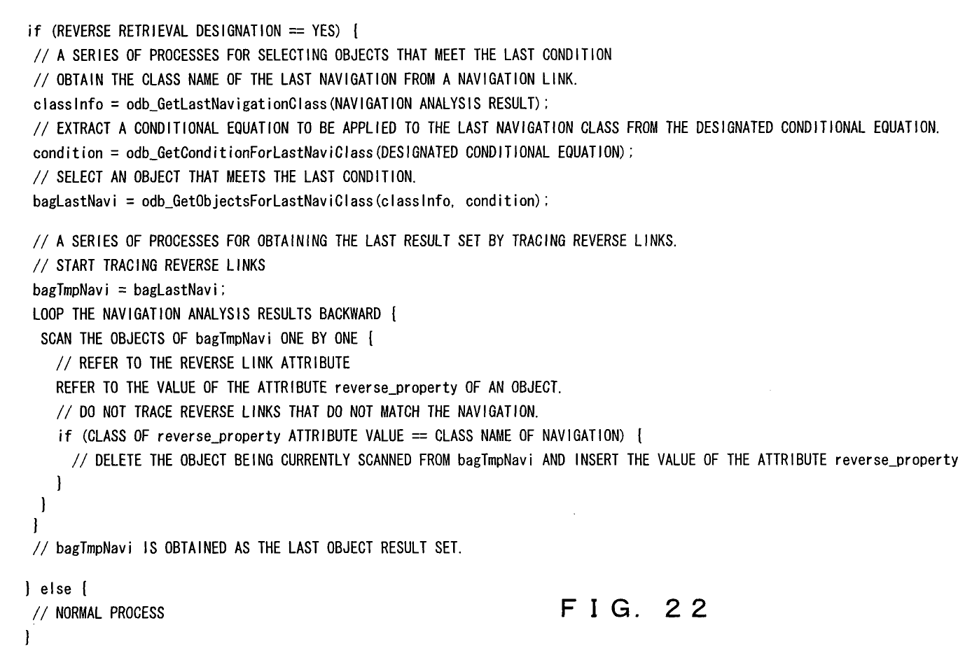

FIGS. 21 and 22 show the algorithm of the process according to the preferred embodiment of the present invention as a pseudo-code.

FIG. 21 shows data to input when the algorithm shown in FIG. 22 operates. FIG. 21 shows a result obtained by analyzing the navigation of a given conditional equation. In addition, the designated conditional equation is also inputted as the input of the algorithm shown in FIG. 22. The output of the algorithm shown in FIG. 22 is a result set of the retrieval.

In FIG. 21, as a result of the navigation analysis, at least a link to subsequent navigation, the name of a class, or the attribute of a link are extracted. Furthermore, other pieces of information may also be obtained depending on the number of conditions or as requested.

FIG. 22 shows the pseudo-code of a portion, whose backward navigation solution a user has designated.

It is determined whether a user has designated backward retrieval, based on the first if statement. If backward retrieval has not been designated, a reply to an inquiry is generated by a “normal process” in an else statement, that is, the conventional process.

If it is determined that backward retrieval has been designated in the first if statement, then, a series of processes of selecting objects that meet the last condition are performed. Specifically, the class name of the last navigation is obtained from a navigation link. This class name is obtained by inputting the result of the navigation analysis to a sub-routine “odb_GetLastNavigationClass” and assigning the obtained class name to a variable “classInfo”.

Then, a conditional equation applied to the last navigation class is extracted from the designated conditional equation. This equation can be extracted by assigning the designated conditional equation to a sub-routine “odb_GetConditionForLastNaviClass” and assigning a variable “condition” to the conditional equation.

Furthermore, objects that meet the last condition are selected. The objects can be obtained by inputting “classinfo” and “condition” to a sub-routine “odb_GetObjectsForLastNaviClass” and assigning the obtained objects to a variable “bagLastNavi”.

Then, a series of processes for obtaining the last result set are performed by tracing reverse links.

Firstly, In order to trace reverse links, “baglastNavi” is assigned to “bagTmpNavi”. Then, the process loop of looping the result of navigation analysis backward is performed. Firstly, the objects of “bagTmpNavi” are scanned one by one. Specifically, in order to refer to the attribute of a reverse link, the attribute value of “reserve_property” in which the reverse link destination of the object is set, is referenced. In this case, it is determined whether the class of. the attribute value of the “reverse_property” is the same as that of the navigation so as not to trace reverse links that do not match the navigation. Only when a link matches the navigation, is an object that is currently being scanned deleted from the “bagTmpNavi”, and the attribute value of the “reverse_property” is inserted. If the process of looping the result of the navigation analysis that has been described above is performed up to the beginning of the navigation, the “bagTmpNavi” is obtained as the last object result set.

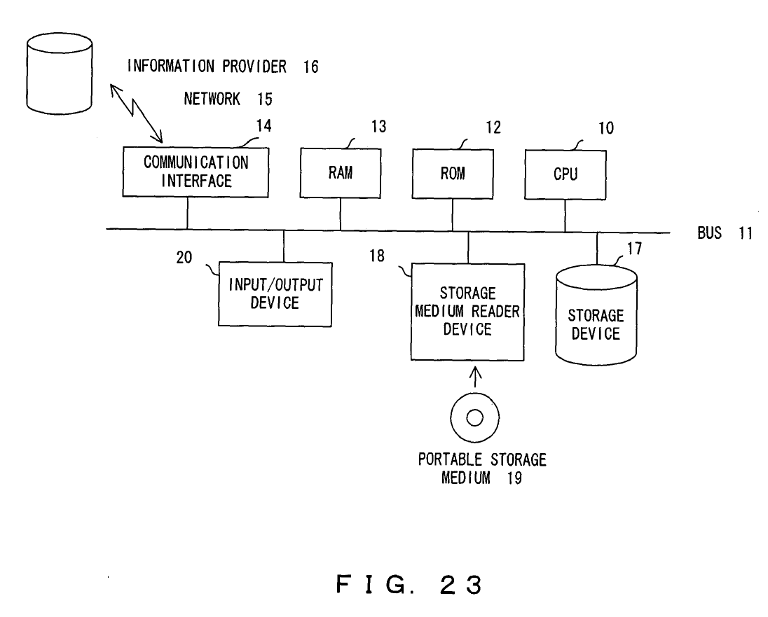

FIG. 23 shows the hardware configuration of a data processing device needed to execute a program when the process of the preferred embodiment of the present invention is realized by a program.

A program for realizing the preferred embodiment of the present invention is stored in a ROM 12 or a RAM 13 and is executed by a CPU 10. The program code from the ROM 12 or RAM 13 is sent to the CPU 10 through a bus 11. The calculation result of the CPU 10 is sent to the RAM 13. The calculation result sent to the RAM 13 is presented to a user by the input/output device, including a display and the like.

The input/output device 20 includes a keyboard for inputting user's instructions, mouse, a template and the like, in addition to a display. The program for realizing the preferred embodiment of the present invention is stored in a storage device 17, such as a hard disk or the like, or a portable storage medium 19 before it is stored in the RAM 13. The program is directly transferred from the storage device 17 to the RAM 13 through a bus 11 and is stored in the RAM 13. Then, the program is executed by the CPU 10.

The program stored in the portable storage medium 19 is read by a reader device 18, is stored in the RAM 13 through the bus 11 and is executed by the CPU 10.

A communication interface 14 can access the database of an information provider 16 or the like through a network 15 and can download the program. The downloaded program is stored in the storage device 17 or portable storage medium 19.

The program downloaded and stored in the storage device 17 or portable storage medium 19 is stored in the RAM 13 and is executed by the CPU 10, as described above.

Alternatively, The program can be executed in a network environment by accessing the information provider 16 using the communication interface 14 and network 15.

According to the present invention, when a database system performs the process of extracting a partial set that meets specific conditions, from a mother set having many elements in an object-oriented database, using an inquiry equation, an answer can be obtained more efficiently and at higher speed.

What is claimed is:

1. A program for enabling a data processing device to realize a retrieval method of an object-oriented database, comprising:
inputting an inquiry for the object-oriented database;
analyzing navigation described in the inquiry;
evaluating the last conditional equation described in the navigation and solving the last conditional equation described in the navigation in a direction the reverse of that of description; and
collecting results obtained by solving the described navigation backward.

2. The program according to claim 1, wherein
the last conditional equation described in the navigation specifically designates a value of an instance in a class.

3. The program according to claim 1, wherein
when a user defines a link between instances in the object-oriented database, the retrieval method automatically establishes a link the reverse of that designated by the user.

4. The program according to claim 3, wherein
when a link between instances is traced in a direction the reverse of that of description in the navigation, a link that is not described in the navigation is not traced even if there is such a link between instances.

5. The program according to claim 1, wherein
the inquiry extracts a partial set that meets the last conditional equation of the navigation, from a mother set of instances belonging to a class described at the beginning of the navigation.

6. A retrieval device for an object-oriented database, comprising:
an input unit inputting an inquiry for the object-oriented database;
an inquiry analysis unit analyzing navigation described in the inquiry;
a backward navigation solution unit evaluating the last conditional equation described in the navigation and solving the last conditional equation described in the navigation in a direction the reverse of that of description; and
a result collection unit collecting results obtained by solving the described navigation backward.

7. A retrieval method for an object-oriented database, comprising:
inputting an inquiry for the object-oriented database;
analyzing navigation described in the inquiry;
evaluating the last conditional equation described in the navigation and solving the last conditional equation described in the navigation in a direction the reverse of that of description; and
collecting results obtained by solving the described navigation backward.
